(19) United States
(12) Patent Application Publication
(10) Pub. No.: US 2022/0383167 A1
(43) Pub. Date: Dec. 1, 2022

(54) BIAS DETECTION AND EXPLAINABILITY OF DEEP LEARNING MODELS

(71) Applicant: Siemens Corporation, Iselin, NJ (US)

(72) Inventors: Janani Venugopalan, Plainsboro, NJ (US); Sudipta Pathak, Lawrence, NJ (US); Wei Xia, Raritan, NJ (US); Sanjeev Srivastava, Chantilly, VA (US); Arun Ramamurthy, Plainsboro, NJ (US)

(21) Appl. No.: 17/786,314

(22) PCT Filed: Aug. 28, 2020
(86) PCT No.: PCT/US2020/048401

§ 371 Date: Jun. 16, 2022

Related U.S. Application Data
(60) Provisional application No. 62/954,727, filed on Dec. 30, 2019.

(30) Foreign Application Priority Data
Jun. 7, 2021 (EP) 21178050.7

(51) Int. Cl. G06N 7/00; G06N 3/063

(52) U.S. Cl. CPC G06N 7/005; G06N 3/063

(57) ABSTRACT

System and method for latent bias detection by artificial intelligence modeling of human decision making using time series prediction data and events data of survey participants along with personal characteristics data for the participants. A deep Bayesian model solves for a bias distribution that fits a modeled prediction distribution of time series event data and personal characteristics data to a prediction probability distribution derived by a recurrent neural network. Sets of group bias clusters are evaluated for key features of related personal characteristics. Causal graphs are defined from dependency graphs of the key features. Bias explainability is inferred by perturbation in the deep Bayesian model of a subset of features from the causal graph, determining which causal relationships are most sensitive to alter group membership of participants.

### TECHNICAL FIELD

This application relates to deep learning models. More particularly, this application relates to a system that infers latent group bias from deep learning models of human decisions for improved explainability of the deep learning models.

### BACKGROUND

In the last decade, the deep learning (DL) modeling branch of artificial intelligence (AI) has revolutionized pattern recognition, providing near instantaneous, high quality detection and classification of objects in complex, dynamic scenes. When used in an autonomous system or as a tactical decision aide, DL can improve effectiveness of decision making skills by improving both the speed and quality at which tasks are detected and classified.

Explainability of DL models is desirable to provide higher confidence in the predictions. For example, after training “black box” DL networks, there remains uncertainty whether the loss functions have accurately behaved in finding the most similar match between a test input and a known input. In the domain of human decision-making models, one area of uncertainty lies with presence of latent human bias in training data. For example, in attempting to develop a DL model for human predictions, the training data may consist of thousands of event predictions. While the DL model can parameterize various known influences on the predictions to learn the human decision-making process, latent aspects, such as bias, leave a gap in attaining a complete modelling. As an illustrative example, when attempting to model decision making, such as for a particular task, there are various sources of bias that can skew the data driven model. Such sources of bias can include implicit and unobserved bias from traits and characteristics by which persons identify themselves as part of a group (perhaps even subconsciously or unknowingly), leading to implicit biased group behavior. Since causes are unobserved for such implicit bias related to common group traits and biased group membership, modeling with explainable bias has yet to be developed.

In prior works, a traditional Bayesian Network (BN) has been used to construct models for representing human cognition and decision-making. It allows an expert to specify a model of a decision-making process in terms of a generative probabilistic story that often agrees with human intuition about the underlying cognitive process. Typically, the structure of a BN is pre-specified, and the parameters of the probabilistic models are chosen a priori. However, it is NP-complete (i.e., time consuming and often addressed by using heuristic methods and approximations) to perform inference and learning in such models. This is especially a problem for a largely complex BN.

A class of deep-probabilistic models (DPM) called Deep-Bayesian Models (DBM) can be deployed for modeling human-decision making. The explainable AI for a DBM is based on mutual information, gradient-based techniques and correlation-based analysis. As a result, unlike traditional BNs, there are no existing techniques to perform causal inference on DBMs or the results of DBM.

### SUMMARY

Disclosed method and system can address all the above-mentioned challenges using causal reasoning and perturbation analysis to determine latent bias present in decision data for improvement to decision prediction models. A deep Bayesian model (DBM) learns prediction distributions and identifies group bias clusters from modeled prediction data and associated personal characteristics data. Key features from personal characteristics data related to group bias clusters are correlated in a fully connected dependency graph. A causal graph is constructed based on the dependency graph to identify causal relations of the key features to the group bias clusters. Perturbation of individual key features having causal relations reveals sensitivity of features for more robust correlation of bias or preference to the prediction data according to particular features of personal traits, providing explainability in the deep learning model for latent bias.

A resultant model may enhance explainability in the following ways: (1) provide the details about why the DBM predicted a certain response for an individual; (2) directly provide which data descriptors (e.g., personal characteristic features) are responsible for the bias; (3) directly provide a rationale on how the data descriptors are related and which ones can produce the greatest response changes.

### BRIEF DESCRIPTION OF THE DRAWINGS

Non-limiting and non-exhaustive embodiments of the present embodiments are described with reference to the following FIGURES, wherein like reference numerals refer to like elements throughout the drawings unless otherwise specified.

FIG. 1 shows an example of a computer vision system with improved retrieval of best matched 3D models for target objects in accordance with embodiments of this disclosure.

FIG. 2A illustrates an example of a deep Bayesian model (DBM) in accordance with embodiments of this disclosure.

FIG. 2B illustrates a modified version of the DBM shown in FIG. 2B for estimating group bias clusters in accordance with embodiments of the disclosure.

FIG. 3 shows an example of flowchart for a process that models explainable latent bias extracted from decision modeling according to embodiments of this disclosure.

FIG. 4 illustrates an example of a computing environment within which embodiments of the disclosure may be implemented.

### DETAILED DESCRIPTION

Methods and systems disclosed address the problem of understanding human bias within decisions, which has various applications in industry, such as learning the contribution of bias on user preference when constructing design software that can anticipate or estimate user preference based on past data with the user. Other examples include software for forecasting, and root cause inferences, which can be affected by human bias developed from repeated past experiences. Using artificial intelligence, observations of decision data is examined for patterns to develop group clusters suggesting group bias, from which deeper examination and perturbation can reveal explanation for which key features define the group and which factors would force a member out of the group. From this understanding, correlation and causality can be extracted to detect the presence of bias or preference for the observed decisions. In addition to detecting bias, the disclosed framework also identifies which human feature or trait (cultural, competence, gender, education, work experience, technical background, etc.) is most responsible for the detected bias or preference. As a simplistic example, it can be useful in an industrial setting to learn that an operator with a mechanical background tends to make decisions that may infer failure diagnosis decisions that lean predominantly toward a mechanical cause, influenced by a technical background bias, which can impede the troubleshooting process.

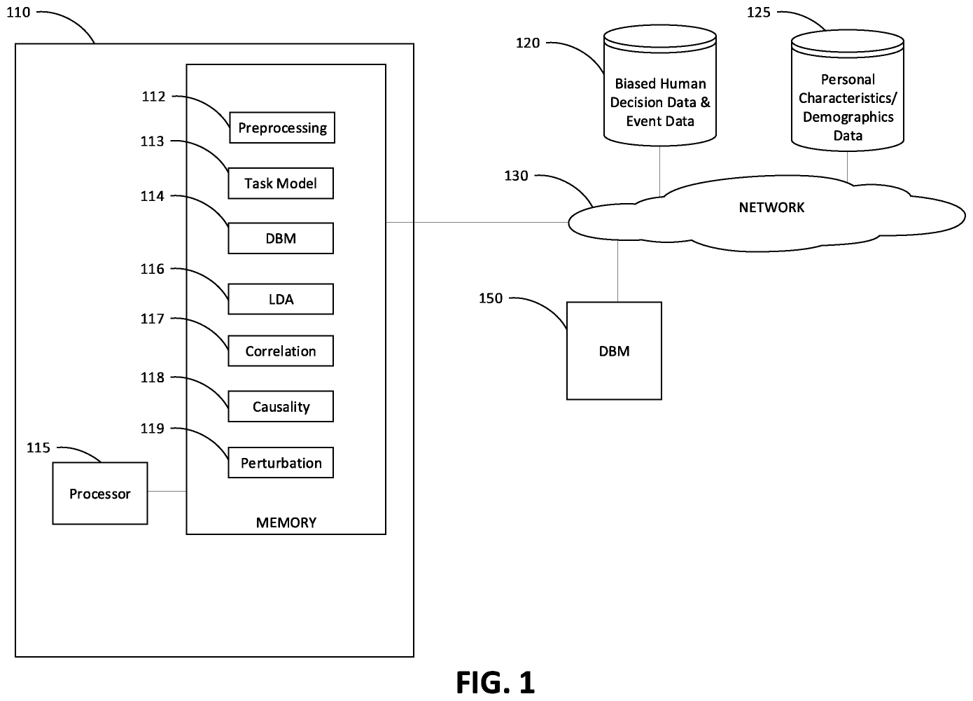

FIG. 1 shows an example of a system for a data driven model to infer group bias for an improved explainable model construction of human decision making in accordance with embodiments of this disclosure. In an embodiment, a system includes a computing device 110, which includes a processor 115 and memory 111 (e.g., a non-transitory computer readable media) on which is stored various computer applications, modules or executable programs. Such modules include a preprocessing module 112, local deep Bayesian model (DBM) module 114, topic module 116, correlation module 117, causality module 118, and perturbation module 119.

Local DBM module 114 is a client module used to interface with a cloud-based or web-based DBM 150 for determining group bias clusters from biased human decision data and event data 120, and personal characteristics/demographics data 125 (i.e., data descriptors for data 120). Network 130, such as a local area network (LAN), wide area network (WAN), or an internet based network, connects computing device 110, DBM 150 and data repositories 120, 125.

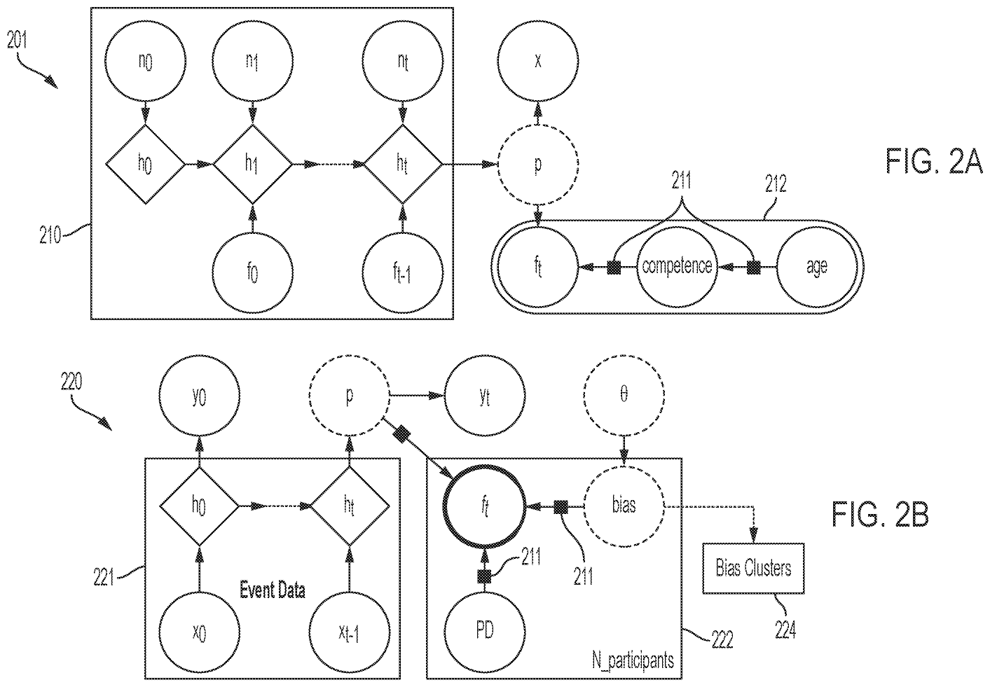

FIG. 2A illustrates an example of a DBM in accordance with embodiments of this disclosure. A Bayesian network (BN) is useful for modeling prediction and has characteristics defined by distributions. In this disclosure, a deep Bayesian model (DBM) is applied, which implements deep learning (DL) networks to parameterize the distributions of the Bayesian network and to predict the parameters. DBM 201 includes a DL network 210 and a BN 212 in which some (or all) of the relationships between the variables, model parameters, and data are expressed using DL algorithms as function approximators. As shown in FIG. 2A, an unobserved variable p represents the true probability of some event x. A human expert produces a time series of “forecasts”f=f₁, . . . , fₜ₋₁. A series of auxiliary information n=n₀, . . . , nₜ (e.g., news headlines) is processed along with f by a Recurrent Neural Network (RNN) 210, where h=h₀, h₁, . . . , hₜ can predict probability distribution p. In a DBM, each fᵢ and nᵢ is a random variable, and their relationship with p is a probability distribution, parameterized by the RNN 210. A Bayesian model 212 of the forecaster's decision-making (forecasts) is shown for this simplified case in which age influences competence, which in turn influences fₜ. Variables and parameters may be defined for this example as follows:

nₜ∈ [symbol] ^{N}p∈(0,1)age∈(18, 100)

x∈{0,1} fₜ∈(0,1)competence (c) ∈

[symbol]

P(p|n,f)=Dirichlet[α=RNN(n,f)]

P(x=0|p)=Brnoulli(p)

P(c|age)=Normal[μ=NN(age), σ=NN(age)]

P(fₜ|p,c)=Normal[μ=p,σ=NN(c)]

The relationships between these variables are probability distributions whose parameters are expressed by DL neural networks 211. Generally, such a predictive model 212 can additionally include multiple forecasters, complex forecaster models, as well as any auxiliary data (time series or not).

Using DL to express probabilistic parameters of a DBM increases flexibility of the models, and decreases their bias, as the human expert needs not restrict the probabilistic relationships to simple functional forms. Complex non-linear relationships between large heterogeneous data and probabilistic parameters of an interpretable model are expressed by DL algorithms. Otherwise, the DBM can be used as any BN, whereby given values of some of the variables, the distributions of the others can be estimated, max-likelihood values obtained, and so on.

Bayesian networks are interpretable by design. Visualizing the DL algorithms that estimate the functional relationships is very challenging. In an embodiment, the DL components can be hidden while only exposing the BN to the user. The DBM decision models can be executed to yield useful action recommendations. The DBM can compute a posterior p(x|data, model), which is the probability of a target variable x given the decision-making model as well as any available data. Maximum-a-posteriori value of x is the optimal decision according to the model and data. The basis of each suggestion is traceable through the network. Measures such as mutual information or average causal effect (ACE) quantify the strength of connections in a DBM. The disclosed framework supports explainability of its recommendations by tracing the influence on the decision node backwards through the BN. One of the main benefits of using a Bayesian framework is the ability to evaluate models in a rigorous, unbiased way in terms of evidence, that is the likelihood of the data given model assumptions. Computing model evidence involves, for all but the simplest models, solving a difficult non-analytical integration problem. Traditional methods such as Markov Chain Monte Carlo or Nested Sampling are time-consuming and often require task-specific adjustments. In contrast, variational inference with DBM model evidence is a first-class object. In the disclosed framework, approximate model evidence is directly optimized during training. Its approximation is readily available during training and inference. This enables the disclosed framework to support comparison and evaluation of competing models of decision-making. The framework continuously re-evaluates the evidence of multiple competing models using streaming data.

FIG. 2B illustrates a modified version of DBM 201 for estimating group bias clusters in accordance with embodiments of the disclosure. DBM 220, as a variation of the DBM shown in FIG. 2A, models observed time series event data x using temporal deep learning RNN 221. The response at time t is used to parameterize the distribution for the actual event probability p based on the eventual outcome of the surveyed predictions. The probability distribution p feeds into BN 222 for biased behavior prediction. In an embodiment, RNN 221 models event data which occurred (e.g., questions and correct options), such as survey questions X∈x₀, . . . , xₜ and participant response Y∈y₀, . . . , yₜ. RNN 221 models true probability p of events given historical data of predictions. The response yₜ at time t is used to parameterize the distribution for the true event probability p. BN 222 (e.g., applying latent Dirichlet allocation or hierarchical Bayesian model) takes the input of the probabilities p of historical events from RNN model 221, latent bias estimates, and personal characteristics data PD to construct a prediction model fₜ, which models the distribution of observed decision data as predicted behavior F∈f₀, . . . , fₜ. The BN 222 models an estimated bias distribution representing latent bias over time, modeled as a hidden node bias. The initial distribution for the bias node is modeled by one or more prior parameters θ. The distributions pertaining to personal characteristics data PD, bias distribution bias and event probability p feed into the prediction model fₜ. The relationships between these variables are probability distributions whose parameters are expressed by DL neural networks 211. In an embodiment, separate nodes are modeled for each category of personal characteristics data (e.g., competence, gender, technical experience). The value of bias distributions which represent the characteristics of the bias clusters survey participants (reflecting age, competence, education, etc.) are estimated. In an embodiment, a curve fitting analysis is applied to solve for the bias distribution that best fits the prediction distribution fₜ to the actual prediction distribution p. Once the curve fitting converges, the final parameter values of the curve fitting function (e.g., parameters of a latent Dirichlet analysis (LDA)) associated with each participant are examined collectively for presence of clusters of similar values. From these clustered values, group bias clusters 224 are defined.

In an embodiment, the BN 222 incorporates an LDA algorithm as described above. Conventionally, an LDA is useful for extracting topics from documents, where a document is a mixture of latent topics, each word is sampled from a distribution corresponding to one of the topics. This functionality of an LDA is extended to an objective at hand in this disclosure, which is for sampling each decision from a distribution corresponding to one of the latent biases. In an embodiment, an LDA algorithm is applied to time series data 320 to group related tasks together, such that the DBM

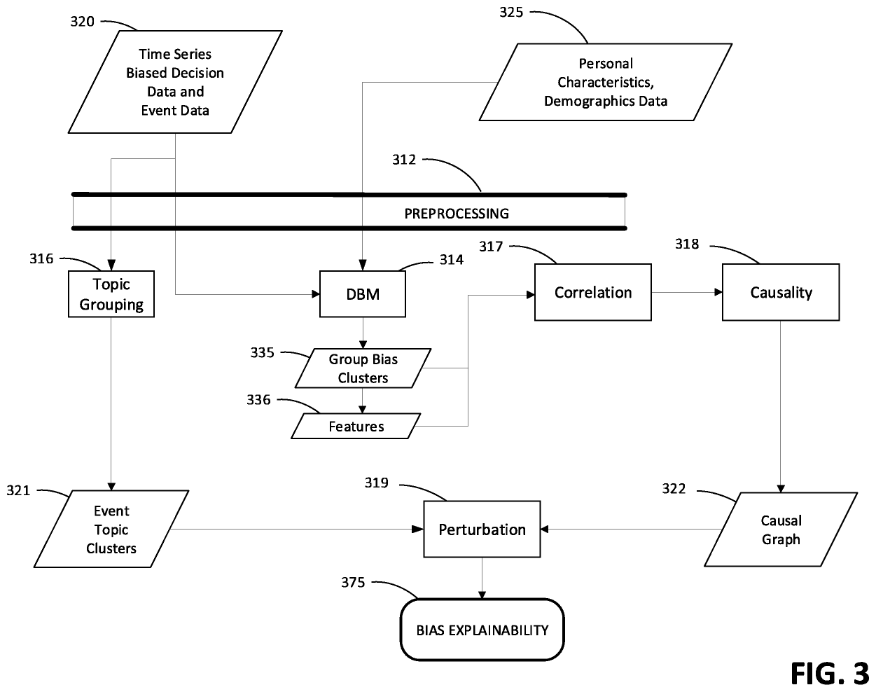

FIG. 3 shows an example of flowchart for constructing an explainability model of human decision making that includes group bias inference. In an embodiment, a virtual (computer-based) decision model is sought for a particular task or topic in which decisions are critical to the task. For such a decision model to have optimum confidence in predicting decisions, latent bias or preference is to be an included element. The process for the disclosed framework involves modeling prediction or decision events for a given task domain based on collected data from numerous human predictions or decisions. From the prediction/decision data model, group bias clusters can be derived using a deep Bayesian model and correlated to common key features of personal characteristics and demographics data. Further processing includes causality graphs and perturbation for sensitivity, which yields an explainability model for latent bias or preference present in the prediction or decision data.

In an embodiment related to the task of human predictions, two forms of data are gathered for the modeling: (1) human decision data and event data from which latent bias is to be discovered, and (2) personal characteristics data collected as data descriptors for the decision data, characterizing competence along with other traits useful for finding cluster patterns that can be used to infer group related bias. Time series human decision and event data 320 may be gathered from surveys (e.g., question/answer format) of multiple participants, the surveys related to prediction of future events. Decision and event data 320 may capture forecast decisions over time from participants to collect data related to future events useful for a prediction model. Participants may be asked questions related to predictions or forecast decisions for a target task or topic. For example, the questions may pertain to voting on options, or a yes/no option. There may be a probability value attached to each question (e.g., “how certain are you about your vote?”, “how probable is your predicted outcome?”). Some surveys can run across long periods of time to generate a change distribution. For example, surveys may be repeated monthly over the course of a year leading up to a selected date for predicting an event. The actual outcomes for the predicted events are recorded and included with the archived time series event data 320, which is useful for modeling the prediction data and tracking probability for whether the prediction was true. In some embodiments, data set 320 may include data for as many as 1,000,000 to 3,000,000 predictions.

In other embodiments, time series and event data 320 relates to observed behavior of participants in performing other types of tasks, other than forecasting. For example, the DL model may learn to predict binary decisions to perform or not perform a task in a given situation. In such cases, explainability of the DL model is sought with respect to latent bias affecting such decisions.

Personal characteristics/demographics data 325 are data descriptors for the time series event data 320, and may include a series of personal characteristics, such as gender, education level, and competence test scores for the surveyed individuals. An objective when collecting the data may be to learn cultural influences (e.g., food, religion, region, language) which can identify common group traits of individuals, where normally bias is implicit and causes of decisions or predictions are unobserved. Examples of other traits leading to implicit biases discovered from prediction data can include one or more of the following: whether experience changes the voting behavior, whether age or gender influences the forecast decisions for a given topic, whether training changes to response to questions. Personal characteristics/demographics data 325 may characterize competence and may be used for identifying bias traits. In an aspect, detailed psychological and cognitive evaluation (e.g., approximately 20 measures) of the decision-makers may include Raven's progressive matrix, cognitive reflection tests, berlin numeracy, Shipley abstraction and vocabulary test scores, political and financial knowledge, numeracy, working memory and similar test scores, demographic data (e.g., gender, age, education levels), self-evaluation (e.g., conscientiousness, openness to experience, extraversion, grit, social value orientation, cultural worldview, need for closure).

Data preprocessing 312 is performed on time series data 320 and personal characteristics/demographics data 325, and may include: (1) data cleaning of errors, inconsistencies and missing data; (2) data integration to integrate data from multiple files and for mapping data using relationships across files; (3) feature extraction for reduction of dimensionality, such as deep feature mapping (e.g., Word2vec) and feature reduction (e.g., PCA, tSNE); and (4) data transformation and temporal data visualization, such as normalization.

Topic grouping module 316 performs exploratory topics data analysis, which generates results indicating event topic groups 321 for the survey questions x and can identify similar questions for explaining the effect of the tasks on the group bias clusters. As with cultural models, it is assumed that behaviors (e.g., decisions) of a group bias cluster would be dictated by the scenario under consideration, i.e., topic associated with the task in the dataset context. The topic grouping module 316 groups related questions and event tasks together using an LDA analysis.

DBM module 314 receives data from task based model 313 and personal characteristics/demographics data 325, determines a prediction probability p from event data and determines estimated group bias clusters 335, using the process as described above in FIG. 2B, where event data x corresponds to time series data 320, and PD corresponds to personal characteristics/demographics data 325. In an embodiment, a cluster identifier function of DBM module 314 applies a parametric curve fitting analysis (e.g., latent Dirichlet analysis) to identify which participant belongs to which group bias cluster, and determines sets of group bias clusters from the input data. From the group clustering and associated data descriptors (personal characteristics/demographics), a key feature extractor of DBM module 314 identifies key features 336 as those features of personal characteristics which are common among participants in the group.

Since DBM models are not classification models but are inspired from topic models (e.g., latent Dirichlet analysis (LDA)), evaluation criteria such as accuracy, precision-recall, and area under the curve are not applicable. For topic models involving documents, the evaluation is performed by first determining the topics of each document using LDA and then evaluating the appropriateness of the topics obtained. In an embodiment of the DBM analysis, a similar approach is performed, where the group bias clusters with shared personal-characteristics features indicate the key features which explain the groupings. In an aspect, a cross-validation and a “cosine similarity metric” on the grouping is performed to obtain a numerical score. As an example, the participants are divided into n=50 equal parts by random composition of 90% of the participants. Group bias models are determined based on each part using DBM 314. For each model, instance-wise feature selection is conducted for each user by the personal characteristic data. The common selected features under each group is determined for each model using cosine similarity. Next, DBM 314 determines if the same group bias cluster discovered by different data shares the similar common features. The group matching may be determined by mapping a group with a group having highest Matthews correlation coefficient.

Correlation module 317 takes each of the identified group bias clusters 335 and estimates the correlation between identified key features 336 through the use of a dependency network analysis, resulting in a fully-connected dependency graph with C₂^{m} connections. In an embodiment, the dependency analysis network utilizes singular value decomposition to compute the partial correlations between features of the dependency network (e.g., by performing partial correlations between columns of the dataset, or between network nodes). The computation of the dependencies is based on finding areas of the dependency network with highest “node activities”, defined by influence of a node with respect to other network nodes. These node activities represent the average influence of a node j on the pairwise correlations C(i,k) for all nodes i, k|N. The correlation influence is derived by a difference between correlations C(i,k) and partial correlations PC as expressed by the following relationship:

d(i,k|j)=C(i,k)−PC(i,k|j)

where i, j, k represent node numbers in the network.

A total influence D(i,j) represents total influence of node j to node i, defined as average influence of node j on the correlations C(i,k), over all nodes k expressed as follows:

$$D ( i , j ) = \frac{1}{N - 1} {\sum }_{i \neq j}^{N - 1} d ( i , k \vert j )$$

Node activity of node j is then computed as the sum value for D(i,j):

$${\sum }_{i \neq j}^{N - 1} D ( i , j )$$

A fixed number of top features (e.g., top 10, 20, or 50) with the highest node activities are selected and utilized to perform a causality analysis.

Causality module 318 uses a subset of features from the results of the correlation module 317 to derive for each of the group bias clusters a causal graph 322 from a dependency graph by pruning non-causal relationships of the dependency graph. The causal graph 322 provides the causal relationship between the participant characteristics/data descriptors (i.e., the dependency graph features) in the dataset for each group bias cluster and for all group bias clusters combined. In an embodiment, the causality analysis uses a greedy equivalence search (GES) algorithm to obtain the causal relations and to construct causal graphs. GES is a score-based algorithm that greedily maximizes a score function (typically the Bayesian Information Criterion (BIC) score) in the space of essential (i.e., observational) graphs in three phases starting from the empty graph: a forward phase, a backward phase and a turning phase. In the forward phase, GES algorithm moves through the space of essential graphs in steps that correspond to the addition of a single edge in the space of directed acyclic graphs (DAGs), the phase is aborted as soon as the score cannot be augmented any more. In the backward phase, the algorithm performs moves that correspond to the removal of a single edge in the space of DAGs until the score cannot be augmented anymore. In the turning phase, the algorithm performs moves that correspond to the reversal of a single arrow in the space of DAGs until the score cannot be augmented any more. GES algorithm cycles through these three phases until no augmentation of the score is possible anymore. In brief, GES algorithm maximizes a score function over graph space. Since the graph space is too large, a “greedy” method is applied. The rationale behind the use of GES scores for causality is as follows. In order to estimate an accurate causal DAG, two key assumptions need to hold theoretically: (1) Causal sufficiency refers to the absence of hidden (or latent) variables, and (2) Causal faithfulness is defined as follows: If X_A and X_B are conditionally independent given X_S, then A and B are d-separated by S in the causal DAG. However, empirically, if these assumptions do not hold, the performance of GES algorithm is still acceptable when number of nodes is not very large. In an embodiment, the causal relation may be pre-specified based on expert knowledge prior to obtaining the data-driven causal network using the GES algorithm. In an embodiment, the causality module 318 is configured to additionally perform counterfactual analysis to determine the effect of enforcing a particular edge on the causal graph 322. In an aspect, the edge enforcement may be user-specified using a graphical user interface, on which GUI responsive changes to the network may be observed, based on observed data using the GES algorithm.

Perturbation module 319 refines the results of the causal module 318 so that bias explainability 375 can be inferred. While causal graph 322 gives relationships between nodes, it does not provide information about how much change to each node (node sensitivity) is enough to alter a survey response and/or group bias cluster membership of a participant. To estimate the changes, perturbation module 319 selects individual features from causal graph 322 (i.e., subset of features determined to be causal), perturbs the selected features in the DBM 314, and evaluates the response to group memberships. If the perturbation of a specific feature X results in a change in the question response for the majority of the group members, then the feature X becomes a likely explanation for the behavior of the group bias cluster for that specific topic. Bias explainability 375 indicates the one or more personal characteristic features as being the highest influencers are most likely to be the cause of group bias in the decision and event data 310. For example, a sensitivity score may be assigned to each perturbed feature based on the number of group members that changed group affiliation (e.g., by changing answer to prediction survey question).

As with cultural models, it is assumed that behavior of a group bias cluster would be dictated by the scenario, i.e., topic associated with the task in the dataset context, under consideration. The perturbation of individual features derived from the causal graph can indicate a change in an individual's perspective or preference to a certain task belonging to a given topic. In an embodiment, this preference change also contributes to the inferred bias explanation 375, indicating another factor of latent bias. To detect this topic based preference, perturbation module 319 includes the event topic groups 321 in the explainability inference 375. If it is observed that the change in a certain feature results in a persistent change to an individual's perspective or preference across a majority of the tasks belonging to a certain topic, the observation identifies a relationship between personal characteristic, the topic associated with the event under consideration, and the bias with the model, providing a probabilistic estimate for the confidence associated with these estimates.

Advantages provided by the above described modeling are numerous. Any field that applies decisions or forecasting can be greatly improved by understanding latent bias embedded in the process. Once the group bias for the given task or topic is learned from the above described system and process, any computer-based modeling of decisions can be better at predicting outcomes. For example, designing automated assistance systems with contingency models, such as in automobiles or other auto-assisted vehicles, can be improved to anticipate operator behavior with knowledge of latent bias or preference during different operation situations and for different demographics. Such models may be tuned to the driver according to personal characteristics, for instance, taking into account the learned preference for such a person. Other such decision modeling applications abound.

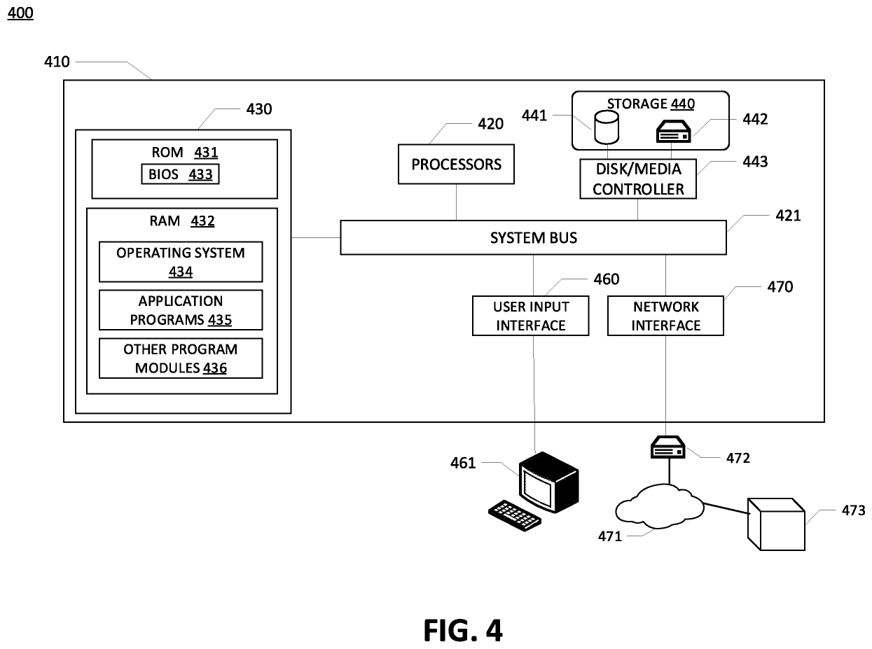

FIG. 4 illustrates an example of a computing environment within which embodiments of the present disclosure may be implemented. A computing environment 400 includes a computer system 410 that may include a communication mechanism such as a system bus 421 or other communication mechanism for communicating information within the computer system 410. The computer system 410 further includes one or more processors 420 coupled with the system bus 421 for processing the information. In an embodiment, computing environment 400 corresponds to the disclosed system that infers bias from human decision data, in which the computer system 410 relates to a computer described below in greater detail.

The processors 420 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 420 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 421 may include at least one of a system bus, a memory bus, an address bus, or a message bus, and may permit exchange of information (e.g., data (including computer-executable code), signaling, etc.) between various components of the computer system 410. The system bus 421 may include, without limitation, a memory bus or a memory controller, a peripheral bus, an accelerated graphics port, and so forth.

Continuing with reference to FIG. 4, the computer system 410 may also include a system memory 430 coupled to the system bus 421 for storing information and instructions to be executed by processors 420. The system memory 430 may include computer readable storage media in the form of volatile and/or nonvolatile memory, such as read only memory (ROM) 431 and/or random access memory (RAM) 432. The RAM 432 may include other dynamic storage device(s) (e.g., dynamic RAM, static RAM, and synchronous DRAM). The ROM 431 may include other static storage device(s) (e.g., programmable ROM, erasable PROM, and electrically erasable PROM). In addition, the system memory 430 may be used for storing temporary variables or other intermediate information during the execution of instructions by the processors 420. A basic input/output system 433 (BIOS) containing the basic routines that help to transfer information between elements within computer system 410, such as during start-up, may be stored in the ROM 431. RAM 432 may contain data and/or program modules that are immediately accessible to and/or presently being operated on by the processors 420. System memory 430 may additionally include, for example, operating system 434, application modules 435, and other program modules 436. Application modules 435 may include aforementioned modules described for FIG. 1 and may also include a user portal for development of the application program, allowing input parameters to be entered and modified as necessary.

The operating system 434 may be loaded into the memory 430 and may provide an interface between other application software executing on the computer system 410 and hardware resources of the computer system 410. More specifically, the operating system 434 may include a set of computer-executable instructions for managing hardware resources of the computer system 410 and for providing common services to other application programs (e.g., managing memory allocation among various application programs). In certain example embodiments, the operating system 434 may control execution of one or more of the program modules depicted as being stored in the data storage 440. The operating system 434 may include any operating system now known or which may be developed in the future including, but not limited to, any server operating system, any mainframe operating system, or any other proprietary or non-proprietary operating system.

The computer system 410 may also include a disk/media controller 443 coupled to the system bus 421 to control one or more storage devices for storing information and instructions, such as a magnetic hard disk 441 and/or a removable media drive 442 (e.g., floppy disk drive, compact disc drive, tape drive, flash drive, and/or solid state drive). Storage devices 440 may be added to the computer system 410 using an appropriate device interface (e.g., a small computer system interface (SCSI), integrated device electronics (IDE), Universal Serial Bus (USB), or FireWire). Storage devices 441, 442 may be external to the computer system 410.

The computer system 410 may include a user input interface 460 for graphical user interface (GUI) 461, which may comprise one or more input devices, such as a keyboard, touchscreen, tablet and/or a pointing device, for interacting with a computer user and providing information to the processors 420.

The computer system 410 may perform a portion or all of the processing steps of embodiments of the invention in response to the processors 420 executing one or more sequences of one or more instructions contained in a memory, such as the system memory 430. Such instructions may be read into the system memory 430 from another computer readable medium of storage 440, such as the magnetic hard disk 441 or the removable media drive 442. The magnetic hard disk 441 and/or removable media drive 442 may contain one or more data stores and data files used by embodiments of the present disclosure. The data store 440 may include, but are not limited to, databases (e.g., relational, object-oriented, etc.), file systems, flat files, distributed data stores in which data is stored on more than one node of a computer network, peer-to-peer network data stores, or the like. Data store contents and data files may be encrypted to improve security. The processors 420 may also be employed in a multi-processing arrangement to execute the one or more sequences of instructions contained in system memory 430. In alternative embodiments, hard-wired circuitry may be used in place of or in combination with software instructions. Thus, embodiments are not limited to any specific combination of hardware circuitry and software.

As stated above, the computer system 410 may include at least one computer readable medium or memory for holding instructions programmed according to embodiments of the invention and for containing data structures, tables, records, or other data described herein. The term “computer readable medium” as used herein refers to any medium that participates in providing instructions to the processors 420 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 441 or removable media drive 442. Non-limiting examples of volatile media include dynamic memory, such as system memory 430. Non-limiting examples of transmission media include coaxial cables, copper wire, and fiber optics, including the wires that make up the system bus 421. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 400 may further include the computer system 410 operating in a networked environment using logical connections to one or more remote computers, such as remote computing device 473. The network interface 470 may enable communication, for example, with other remote devices 473 or systems and/or the storage devices 441, 442 via the network 471. Remote computing device 473 may be a personal computer (laptop or desktop), a mobile device, a server, a router, a network PC, a peer device or other common network node, and typically includes many or all of the elements described above relative to computer system 410. When used in a networking environment, computer system 410 may include modem 472 for establishing communications over a network 471, such as the Internet. Modem 472 may be connected to system bus 421 via user network interface 470, or via another appropriate mechanism.

Network 471 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 410 and other computers (e.g., remote computing device 473). The network 471 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 471.

It should be appreciated that the program modules, applications, computer-executable instructions, code, or the like depicted in FIG. 4 as being stored in the system memory 430 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 410, the remote device 473, and/or hosted on other computing device(s) accessible via one or more of the network(s) 471, may be provided to support functionality provided by the program modules, applications, or computer-executable code depicted in FIG. 4 and/or additional or alternate functionality. Further, functionality may be modularized differently such that processing described as being supported collectively by the collection of program modules depicted in FIG. 4 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 4 may be implemented, at least partially, in hardware and/or firmware across any number of devices.

It should further be appreciated that the computer system 410 may include alternate and/or additional hardware, software, or firmware components beyond those described or depicted without departing from the scope of the disclosure. More particularly, it should be appreciated that software, firmware, or hardware components depicted as forming part of the computer system 410 are merely illustrative and that some components may not be present or additional components may be provided in various embodiments. While various illustrative program modules have been depicted and described as software modules stored in system memory 430, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. Accordingly, the phrase “based on,” or variants thereof, should be interpreted as “based at least in part on.”

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A system for latent bias detection by artificial intelligence modeling of human decision making, the system comprising:
a processor; and
a non-transitory memory having stored thereon modules executed by the processor, the modules comprising:
a data repository of time series event data comprising predictions of future events by survey participants and event outcomes, the predictions having latent bias;
a data repository of personal characteristics data of each survey participant;
a deep Bayesian model module comprising:
a recurrent neural network for configured to model the time series event data as a prediction probability distribution p,
a Bayesian network with at least a hidden node representing estimated bias distribution and a personal data node representing the personal characteristics data, the Bayesian network configured to receive the probability distribution and solve for a bias distribution that best fits a model prediction distribution f to the prediction probability distribution p;
a cluster identifier configured to define sets of group bias clusters from the bias distribution;
a key feature extractor configured to identify key features according to common personal characteristics within the group bias clusters;
a correlation module configured to receive information related to each of the group bias clusters and to estimate correlation between key identified features using a dependency analysis network to construct for each of the group bias clusters a dependency graph based on singular value decomposition;
a causality module configured to perform a causality analysis to derive for each of the group bias clusters a causal graph from the dependency graph using a greedy equivalence search algorithm to move through the space of essential graphs to construct the causal graph, the causal graph providing causal relationship between personal characteristics in each group bias cluster and for all group bias clusters combined; and
a perturbation module configured to infer bias explainability by perturbing features derived from the causal graph to determine which of the causal relationships are most sensitive to alter group membership of participants, wherein the bias explainability includes an indication of which personal characteristics are the most likely cause for identified group bias clusters based on highest sensitivity values.

2. The system of claim 1, wherein cluster identifier function is configured to apply a curve fitting analysis to solve for the bias distribution that best fits the prediction distribution f to the actual prediction distribution p, and upon convergence of the curve fitting, current parameter values of the curve fitting function associated with each participant are examined collectively for presence of clusters of similar values, which is used to define the sets of group bias clusters.

3. The system of claim 1, wherein the curve fitting analysis is a latent Dirichlet analysis.

4. The system of claim 1, further comprising a topic module configured to determine event topic groups from the time series event data using a latent Dirichlet allocation analysis;
wherein the perturbation module is further configured to include event topic groups for the inferring of bias explainability.

5. The system of claim 1, wherein the causality module is further configured to perform counterfactual analysis to determine the effect of enforcing a particular edge on the causal graph.

6. The system of claim 1, wherein the causality module is further configured to derive the causal graph by pruning non-causal relationships of the dependency graph.

7. The system of claim 1, wherein the correlation module is further configured to determine a number of top features from the dependency graph, the dependency graph comprising a network of nodes representing the features, the top features being ones with highest node activities defined by influence of a node with respect to other nodes, the top features being sent to the causality module for the causality analysis.

8. A method for latent bias detection by artificial intelligence modeling of human decision making, the method comprising:
modelling, by a recurrent neural network, time series event data as a prediction probability distribution p, wherein the time series event data comprising predictions of future events by survey participants and event outcomes, the predictions having latent bias;
receiving, by a Bayesian network with at least a hidden node representing estimated bias distribution and a personal data node representing personal characteristics data of each survey participant, the probability distribution and solving for a bias distribution that best fits a model prediction distribution f to the prediction probability distribution p;
defining sets of group bias clusters from the bias distribution;
identifying key features according to common personal characteristics within the group bias clusters;
estimating correlation between the key identified features using a dependency analysis network to construct for each of the group bias clusters a dependency graph based on singular value decomposition;
performing a causality analysis to derive for each of the group bias clusters a causal graph from the dependency graph using a greedy equivalence search algorithm to move through the space of essential graphs to construct the causal graph, the causal graph providing causal relationship between personal characteristics in each group bias cluster and for all group bias clusters combined; and
inferring bias explainability by perturbing features derived from the causal graph to determine which of the causal relationships are most sensitive to alter group membership of participants, wherein the bias explainability includes an indication of which personal characteristics are the most likely cause for identified group bias clusters based on highest sensitivity values.

9. The method of claim 8, further comprising:
applying a curve fitting analysis to solve for the bias distribution that best fits the prediction distribution f to the actual prediction distribution p, and upon convergence of the curve fitting, current parameter values of the curve fitting function associated with each participant are examined collectively for presence of clusters of similar values, which is used to define the sets of group bias clusters.

10. The method of claim 8, wherein the curve fitting analysis is a latent Dirichlet analysis.

11. The method of claim 8, further comprising:
determining event topic groups from the time series event data using a latent Dirichlet allocation analysis; and
including event topic groups for the inferring of bias explainability.

12. The method of claim 8, further comprising:
performing counterfactual analysis to determine the effect of enforcing a particular edge on the causal graph.

13. The method of claim 8, further comprising:
deriving the causal graph by pruning non-causal relationships of the dependency graph.

14. The method of claim 8, further comprising:
determining a number of top features from the dependency graph, the dependency graph comprising a network of nodes representing the features, the top features being ones with highest node activities defined by influence of a node with respect to other nodes, the top features being sent to the causality module for the causality analysis.
